(19) United States
(12) Patent Application Publication
(10) Pub. No.: US 2022/0185978 A1
(43) Pub. Date: Jun. 16, 2022

(54) Foam Formed From Cellulose Ester Composition

(71) Applicant: Celanese International Corporation, Irving, TX (US)

(72) Inventors: Xiaowei Zhang, Union, KY (US); Kevin Norfleet, Dallas, TX (US); Randy Buchman, Florence, KY (US); Christopher McGrady, Walton, KY (US); Camilo Cano, Union, KY (US); Jonathan Caterino, Union, KY (US); Michael Combs, Shady Spring, WV (US)

(21) Appl. No.: 17/548,139

(22) Filed: Dec. 10, 2021

Related U.S. Application Data
(60) Provisional application No. 63/124,540, filed on Dec. 11, 2020.

(51) Int. Cl. C08J 9/00; C08J 9/04

(52) U.S. Cl. CPC C08J 9/0023; C08J 9/04; C08J 2201/03; C08J 2301/12; C08J 2205/052; C08J 9/0066

(57) ABSTRACT

A biodegradable foam material is disclosed. The biodegradable foam material is made from a cellulose ester polymer combined with at least one plasticizer. The cellulose ester polymer composition is combined with one or more foaming agents and formed into a closed cell foam. The foam material is particularly well suited for use in packaging.

### RELATED APPLICATIONS

The present application is based on and claims priority to U.S. Provisional Patent Application Ser. No. 63/124,540, filed on Dec. 11, 2020, which is incorporated herein by reference.

### BACKGROUND

Each year, the global production of plastics continues to increase. Over one-half of the amount of plastics produced each year are used to produce plastic bottles, containers, drinking straws, and other single-use items. For example, over 100 million disposable plastic straws are manufactured and placed in use every year.

The discarded, single-use plastic articles, including all different kinds of packaging, are typically not recycled and end up in landfills. In addition, many of these items are not properly disposed of and end up in streams, lakes, and in the oceans around the world. In fact, plastic waste tends to agglomerate and concentrate in oceans in certain areas of the world due to currents and the buoyancy of the products.

In view of the above, those skilled in the art have attempted to produce plastic articles made from biodegradable polymers. Many biodegradable polymers, however, lack the physical properties and characteristics of conventional polymers, such as polypropylene and/or polyethylene.

One particular area where significant problems have been faced in replacing petroleum-based polymers is in the production of foamed articles. Polyolefin polymers, such as polyethylene and polypropylene polymers, and polystyrene for instance, are widely used in various foam applications to produce cushions, protective packaging, insulation, sporting goods, medical products, and the like. Linear low density polyethylene, for instance, can be fabricated into foams having a wide range of foam densities using several different processes. Linear low density polyethylene possesses desirable rheological characteristics, such as melt strength and strain hardening, that makes the polymer particularly well suited to producing foamed articles.

A need currently exists, however, for a replacement to polyolefin polymers in the production of foam articles that is biodegradable. More particularly, a need exists for a biodegradable polymer composition that is capable of forming closed cell foams.

### SUMMARY

In general, the present disclosure is directed to a biodegradable polymer composition well suited to producing foamed articles and products with good mechanical performance and processability. In accordance with the present disclosure, the biodegradable polymer composition contains a cellulose ester polymer that is not only biodegradable but can be formed from renewable resources. The cellulose ester polymer composition of the present disclosure can be formulated to have excellent transparency characteristics and melt strength while remaining biodegradable.

In one embodiment, for instance, the present disclosure is directed to a biodegradable foam composition. The form composition includes a closed cell foam formed from a polymer composition comprising a cellulose ester polymer comprising cellulose diacetate. The cellulose diacetate has a degree of acetyl substitution of from about 1.5 to about 3, such as from about 2 to about 3. The cellulose ester polymer is blended with a plasticizer. The plasticizer can be a polyglyceride. The plasticizer is present in the polymer composition in an amount from about 8% to about 45% by weight. The polymer composition further comprises a nucleating agent. Closed cell foams made in accordance with the present disclosure can have a density of less than about 1 g/cm³, such as less than about 0.9 g/cm³, such as less than about 0.8 g/cm³.

The plasticizer, in one embodiment, can comprise a triglyceride. In one aspect, various other plasticizers may be used. Such plasticizers include tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-020 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof. In one particular embodiment, the plasticizer comprises a 1,2,3-triacetylglycol.

The cellulose ester polymer can be present in the polymer composition generally in an amount from about 15% to about 85% by weight, such as in an amount from about 55% to about 80% by weight. In one aspect, the cellulose ester polymer consists essentially of cellulose diacetate.

Various different nucleating agents may be present in the polymer composition used to produce the closed cell foam. The nucleating agent, for instance, can comprise inorganic particles, such as any suitable inorganic mineral. Particular examples of nucleating agents include titanium dioxide, magnesium dioxide, a sodium salt of a polycarbonate acid, carbonate compounds in a polyolefin matrix, talc, or mixtures thereof. The nucleating agent can be present in the polymer composition in an amount up to about 2% by weight.

Various different articles and products can be made from the closed cell foam. In one aspect, the biodegradable foam is in the form of a foam sheet. The closed cell foam, for instance, can be used to produce packaging materials.

The present disclosure is also directed to a process for producing a biodegradable foam. The process includes combining the polymer composition as described above with a foaming agent. Any suitable foaming agent may be used including physical foaming agents, chemical foaming agents, and the like. In one aspect a supercritical fluid is used as a foaming agent in a supercritical fluid injection system. The foaming agent, for example, can comprise a hydrocarbon gas, carbon dioxide, nitrogen gas, or mixtures thereof. Alternatively, the foaming agent can comprise a carboxylic acid and an alkanolamine. The closed cell foam formed from the process can have a density that is at least 8% less, such as at least 10% less, such as at least 15% less than the density of the polymer composition used to form the foam.

The process can utilize any suitable foam forming equipment and systems. For example, the foam can be formed using an extruder, such as a tandem extrusion system or a single screw extruder. A supercritical fluid injection system may also be used.

The resulting foam material can be used in numerous and diverse applications. In addition, the foam material can be further processed as desired. For example, the foam material can be molded into any suitable shape. In one embodiment, the foam material can be used in a thermoforming process to produce various articles and laminates.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figure, in which:

FIG. 1 is a perspective view illustrating a foam article made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a plasticized cellulose ester polymer composition well suited to producing foam articles. In accordance with the present disclosure, the cellulose ester polymer composition is combined with a foaming agent (e.g. blowing agent) and extruded to form a closed cell foam having various beneficial properties. For instance, the polymer composition has excellent melt strength which facilitates processing. Foam articles made according to the present disclosure also have excellent mechanical properties. In addition, the polymer composition is biodegradable providing numerous advantages over using petroleum-based polymers.

The cellulose ester polymer composition of the present disclosure is particularly well suited to producing closed cell foams. The closed cell foams can be used in many different applications. In general, the foam material of the present disclosure can be used to replace polyethylene and/or polypropylene foams made in the past. For example, the foam material of the present disclosure is particularly well suited for use in packaging materials. In one aspect, the foam material can be used to produce food packaging. The foam material can be formed into a freestanding product or can be combined with other materials. For instance, in one aspect, the foam can be combined with a coated board to produce packaging materials.

In accordance with the present disclosure, the polymer composition contains a cellulose ester polymer combined with at least one plasticizer. In addition, the polymer composition contains a nucleating agent and optionally various other additives and ingredients. In forming a foam material, the polymer composition is combined with a foaming agent, such as a gas, and extruded into a foam. The extruded foam material can have any suitable shape. In one aspect, for instance, the foam material is extruded into sheets, planks, profiles, tubes, boards, and the like.

In one embodiment, a foam substrate is formed and then used in a thermoforming process. During thermoforming, the foamed substrate is heated and then manipulated into a desired three-dimensional shape. The substrate can be formed over a male mold or a female mold. There are two main types of thermoforming typically referred to as vacuum forming or pressure forming. Both types of thermoforming use heat and pressure in order to form a foamed substrate into its final shape. During vacuum forming, a foamed substrate is placed over a mold and vacuum is used to manipulate it into a three-dimensional article. During pressure forming, pressure optionally in combination with vacuum forces are used to mold the foamed substrate into a shape.

The use of thermoforming to produce three-dimensional articles has various advantages. For instance, thermoforming allows for the production of all different types of shapes with fast turnaround times. Modifications to designs can also occur quickly and efficiently. Thermoforming can also be cost effective and can produce articles having an aesthetic appearance.

The temperature and pressure to which the foam substrate is subjected during the thermoforming process can vary depending upon various different factors including the thickness of the foam substrate and the type of product being formed. In general, thermoforming may be conducted at a temperature of from about 75° C. to about 120° C., such as from about 75° C. to about 100° C. Higher temperatures, however, can also be used. As described above, the foam substrate is also subjected to pressure and/or suction forces that press the foam substrate against a mold for conforming the foam substrate to the shape of the mold. Once molded, the three-dimensional article can be trimmed and/or polished as desired.

In general, any suitable cellulose ester polymer can be incorporated into the polymer composition of the present disclosure. In one aspect, the cellulose ester polymer is a cellulose acetate.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses oftheMiscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The biodegradation of the cellulose ester polymer can depend upon various factors including the degree of substitution. The degree of substitution of cellulose ester can be measured, for example, using ASTM Test 871-96 (2010). The cellulose acetate polymer incorporated into the polymer composition can generally have a degree of substitution of greater than about 1.5, such as greater than about 2.0, such as greater than about 2.1, such as greater than about 2.2, such as greater than about 2.3. The degree of substitution is generally less than about 3, such as less than about 3.0, such as less than about 2.7, such as less than about 2.6, such as less than about 2.4.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log n \text{?} ) / k ) - 1 ) \\ where n \text{?} = ( \frac{{t}_{1}}{{t}_{2}} ) , \\ \text{?} \text{indicates text missing or illegible when filed} \qquad Equation 1$$

t₁=the average flow time of solution (having cellulose ester) in seconds, t₂₌the average flow times of solvent in seconds, k=solvent constant (10 for 98/2 wt/wt acetone/water), and c=concentration (0.200 g/dL).

The cellulose acetate is generally present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight. The cellulose acetate is generally present in the polymer composition in an amount less than about 85% by weight, such as in an amount less than about 80% by weight, such as in an amount less than about 75% by weight, such as in an amount less than about 70% by weight, such as in an amount less than about 65% by weight.

In accordance with the present disclosure, a cellulose ester polymer is combined with one or more plasticizers.

Plasticizers particularly well suited for use in the polymer composition include polyglycerides. For example, the plasticizer can comprise a monoglyceride, a diglyceride, or a triglyceride. In one particular aspect, the plasticizer comprises 1,2,3-triacetylglycol. In other aspects, however, the plasticizer can be a diacetylglycol or a monoacetylglycol alone or in combination with a triacetylglycol. Other suitable plasticizers include tris(clorisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

In one aspect, the plasticizer is phthalate-free. In fact, the polymer composition can be formulated to be phthalate-free. For instance, phthalates can be present in the polymer composition in an amount of about 0.1% or less, such as in an amount of about 0.001% or less.

In general, one or more plasticizers can be present in the polymer composition in an amount from about 8% to about 45% by weight, such as in an amount from about 20% to about 40% by weight. In one aspect, one or more plasticizers can be present in the polymer composition in an amount of greater than about 21% by weight, such as in an amount greater than about 23% by weight, such as in an amount greater than about 25% by weight, such as in an amount greater than about 27% by weight, such as in an amount greater than about 30% by weight, such as in an amount greater than about 32% by weight, and generally in an amount less than about 38% by weight, such as in an amount less than about 35% by weight.

The cellulose acetate can be present in relation to the plasticizer such that the weight ratio between the cellulose acetate and the one or more plasticizers is from about 60:40 to about 85:15, such as from about 70:30 to about 80:20. In one embodiment, the cellulose acetate to plasticizer weight ratio is about 75:25.

The polymer composition of the present disclosure can also contain a nucleating agent. In one aspect, the nucleating agent can include inorganic particles, such as any suitable mineral particles. Examples of nucleating agents include titanium dioxide, a salt of a polycarbonate acid, such as a sodium salt of a polycarbonate acid, a carbonate compound, such as calcium carbonate, talc, other inorganic mineral particles, silicon oxide, magnesium oxide, aluminum oxide, calcium silicate, cellulose powder, chitin, chitosan, and mixtures thereof. In one aspect, the nucleating agent can be a carbonate compound in a polymer matrix.

The nucleating agent can be present in the polymer composition generally in an amount greater than 0.1% by weight, such as in an amount greater than 0.5% by weight, such as in an amount greater than about 0.7% by weight, such as in an amount greater than about 1% by weight, such as in an amount greater than about 1.1% by weight. One or more nucleating agents are present in the polymer composition generally in an amount less than about 2% by weight, such as in an amount less than about 1.8% by weight, such as in an amount less than about 1.5% by weight, such as in an amount less than about 1.3% by weight.

In addition to a cellulose ester polymer, one or more nucleating agents, and one or more plasticizers, the polymer composition can contain various other additives and ingredients. For example, the polymer composition can contain one or more acid scavengers that can be used to reduce acid emissions, such as acetic acid emissions. Suitable acid scavengers include alkali metal salts, alkaline earth metal salts, a carbonate, an oxide, a hydroxide, an amine, or mixtures thereof. Particular acid scavengers include zinc oxide, magnesium oxide, calcium carbonate, aluminum sodium carbonate, aluminum silicate, a hydrotalcite, and mixtures thereof. One or more acid scavengers can be present in the polymer composition in an amount from about 0.1% to about 5% by weight, such as from about 0.3% to about 2% by weight.

In addition to an acid scavenger as described above, the polymer composition can also contain an odor masking agent. The odor masking agent, for instance, can absorb odors and/or produce its own odor. Masking agents that may be incorporated into the composition include zeolites, particularly synthetic zeolites, fragrances, and the like.

Other additives and ingredients that may be included in the polymer composition include antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTENO available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

In order to form a foam material from the polymer composition, a foaming agent is combined with the polymer composition and subjected to process conditions that cause a foam to form. In one aspect, for instance, the polymer composition and foaming agent are fed through an extruder in order to form the foam material. In one aspect, the foam material can be formed into a sheet. Alternatively, the foam material can be fed to a mold for producing a molded article.

In general, any suitable foaming agent may be used. Suitable foaming agents include both physical foaming agents and chemical foaming agents. In one aspect, a supercritical fluid, such as carbon dioxide or a hydrocarbon, is used as a foaming agent in a supercritical fluid injection system.

Chemical foaming agents include azodicarbonamide, azodiisobutyro-nitrile, benzenesulfonhydrazide, 4,4-oxybenzene sulfonylsemicarbazide, p-toluene sulfonyl semi-carbazide, barium azodicarboxylate, N,N′-dimethyl-N,N′-dinitrosoterephthalamide, and trihydrazino triazine. Some are known by their tradenames, such as Hydrocerol™ by Boehringer Ingelheim Chemical Inc., which is a sodium salt of polycarbonate acid and carbonate compounds in polyolefin matrix. As is known, this has a relatively low initiation temperature and the foaming agent can be selected to have a higher or lower initiation temperature as desired for a given application.

Foaming agents can be organic or inorganic agents. Suitable organic foaming agents include aliphatic hydrocarbons having 1-9 carbon atoms, halogenated aliphatic hydrocarbons, having 1-4 carbon atoms, and aliphatic alcohols having 1-3 carbon atoms. Aliphatic hydrocarbons include methane, ethane, propane, n-butane, isobutane, n-pentane, isopentane, neopentane, and the like. Examples of fluorinated hydrocarbon include methyl fluoride; perfluoromethane; ethyl fluoride; 1,1-difluoroethane (HFC-152a); 1,1,1-trifluoroethane (HFC-143a), 1,1,1,2-tetrafluoro-ethane (HFC-134a), pentafluoroethane; perfluoroethane; 2,2-difluoropropane; 1,1,1-trifluoropropane, perfluoropropane; perfluorobutane; and perfluorocyclobutane. Partially halogenated chlorocarbons and chlorofluorocarbons for use in this invention include methyl chloride; methylene chloride; ethyl chloride; 1,1,1-trichloroethane; 1,1-dichloro-1-fluoroethane (HCFC-141b), 1-chloro-1,1-difluoroethane (HCFC-142b), 1,1-dichloro-2,2,2-trifluoroethane (HCFC-123), and 1-chloro-1,2,2,2-tetrafluoroethane (HCFC-124). Fully halogenated chlorofluorocarbons include trichloromonofluoromethane (CFC-11), dichlorodifluoromethane (CFC-12); trichlorotrifluoroethane (CFC-113), dichlorotetrafluoroethane (CFC-114), chloroheptafluoropropane; and dichlorohexafluoropropane. Aliphatic alcohols useful as foaming agents include methanol, ethanol, n-propanol, and isopropanol.

Suitable inorganic foaming agents include carbon dioxide, nitrogen, argon, water, air, nitrogen, and helium. Inorganic foaming agents also include: sodium bicarbonate; sodium carbonate; ammonium bicarbonate; ammonium carbonate; ammonium nitrite; nitroso compounds, such as N,N′-dimethyl-N,N′-dinitrosoterephthalamide and N,N′-dinitrosopentamethylene tetramine; azo compounds, such as azodicarbonamide, azobisisobutylonitrile, azocyclohexylnitrile, azodiaminobenzene, and bariumazodicarboxylate; sulfonyl hydrazide compounds, such as benzene sulfonyl hydrazide, toluene sulfonyl hydrazide, p,p′-oxybis(benzene sulfonyl hydrazide), and diphenyl sulfone-3,3′-disulfonyl hydrazide; and azide compounds, such as calcium azide, 4,4′-diphenyl disulfonyl azide, and p-toluene sulfonyl azide.

In a preferred embodiment, the foaming agent is selected from the group consisting of: butane, isobutene, carbon dioxide, pentane, hexane, heptane, benzene, toluene, methyl chloride, trichloroethylene, dichloroethane, trichlorofluoromethane.

In one embodiment, the foaming agent can be the combination of a fatty acid and an alkanolamide, such as a mixture of oleic acid and diethanolamide.

The manner in which the foaming agent is added to the cellulose ester polymer composition can depend upon various factors including the type of foaming agent utilized. Gas foaming agents, for instance, can be combined with the polymer composition in an extruder while the polymer composition is in a molten state. Other foaming agents, however, can be compounded with the polymer composition, blended with the polymer composition as it is fed to the extruder, or added to the polymer composition while the polymer composition is in the extruder.

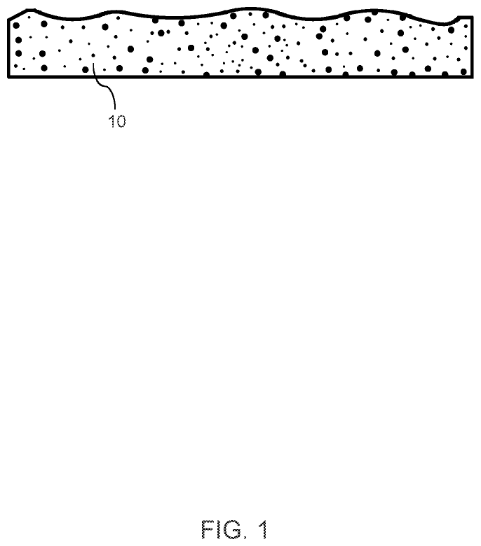

In general, the temperature for melt extrusion of the cellulose ester polymer composition during foaming can be from about 140° C. to about 245° C. The extruder can include a nozzle having any suitable shape for producing a foam material with the desired corresponding shape. As described above, in one embodiment, the extruder can have a discharge die that produces a foam sheet as shown in FIG. 1.

Referring to FIG. 1, the foam sheet 10 is formed from the polymer composition of the present disclosure and, in one aspect, can have a closed cell foam structure.

Foam materials made according to the present disclosure generally have a density of less than about 1 g/cm³. For instance, the density of the foam material can be less than about 0.9 g/cm³, such as less than about 0.8 g/cm³, such as less than about 0.7 g/cm³. The closed cell foam made according to the present disclosure generally has a density that is at least 5%, such as at least 8%, such as at least 10%, such as at least 15%, such as at least 20% less than the initial density of the polymer composition used to produce the foam.

Foam materials made according to the present disclosure can be used in numerous and diverse applications. For instance, the foam materials can be included in consumer goods, industrial goods, construction materials, packaging materials, and automotive parts. Foamed articles made according to the present disclosure can include food packaging, rigid packaging, tubing, structural foam, buoyancy aids, insulation, cushioning applications, and the like.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A biodegradable foam composition comprising:
a closed cell foam formed from a polymer composition comprising a cellulose ester polymer comprising cellulose diacetate, the cellulose diacetate having a degree of acetyl substitution of from about 1.5 to about 3.5, the cellulose ester polymer being blended with a plasticizer, the plasticizer comprising a polyglyceride, the plasticizer being present in the polymer composition in an amount of from about 8% to about 45% by weight, the polymer composition further comprising a nucleating agent and wherein the closed cell foam has a density of less than 1.0 g/cm³.

2. A biodegradable foam composition as defined in claim 1, wherein the closed cell foam has a density of less than 0.9 g/cm³.

3. A biodegradable foam composition as defined in claim 1, wherein the plasticizer comprises a triglyceride.

4. A biodegradable foam composition as defined in claim 1, wherein the plasticizer further comprises tris(clorisopropyl) phosphate, tris(2-chloro-1-methylethyl) phosphate, glycerin, triethyl citrate, acetyl triethyl citrate, an adipate, polyethylene glycol, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, an aromatic diol, a substituted aromatic diol, an aromatic ether, tripropionin, tribenzoin, a glycerin ester, glycerol tribenzoate, glycerol acetate benzoate, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-020 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, a piperidine, a piperazine, hexamethylene diamine, triazine, triazole, a pyrrole, and mixtures thereof.

5. A biodegradable foam composition as defined in claim 1, wherein the plasticizer comprises a 1,2,3-triacetylglycol.

6. A biodegradable foam composition as defined in claim 1, wherein the cellulose diacetate is present in the polymer composition in an amount of from about 15% to about 85% by weight and the plasticizer is present in the composition in an amount of from about 20% to about 40% by weight.

7. A biodegradable foam composition as defined in claim 1, wherein the cellulose ester polymer consists essentially of cellulose diacetate.

8. A biodegradable foam composition as defined in claim 1, wherein the nucleating agent comprises inorganic particles.

9. A biodegradable foam composition as defined in claim 1, wherein the nucleating agent comprises titanium dioxide, a sodium salt of a polycarbonate acid, and carbonate compounds in a polyolefin matrix, talc or an inorganic mineral.

10. A biodegradable foam composition as defined in claim 1, wherein the nucleating agent is present in the biodegradable foam composition in an amount of from about 0% to about 2% by weight.

11. A biodegradable foam composition as defined in claim 1, wherein the foam composition is in the form of a foam sheet.

12. An article made from the biodegradable foam composition as defined in claim 1.

13. An article as defined in claim 12, wherein the article comprises a foam packaging material.

14. A process for producing a biodegradable foam comprising:
combining a polymer composition with a foaming agent, the polymer composition comprising a cellulose ester polymer comprising cellulose diacetate, the cellulose diacetate having a degree of acetyl substitution of from about 1.5 to about 3.5, the polymer composition further comprising a plasticizer that has been blended with the cellulose ester polymer, the plasticizer comprising a polyglyceride, the plasticizer being present in the polymer composition in an amount of from about 8% to about 40% by weight, the polymer composition further comprising a nucleating agent, and wherein the polymer composition and foaming agent are extruded and formed into a closed cell foam, the closed cell foam having a density that is at least 8% less than the density of the polymer composition.

15. A process as defined in claim 14, wherein the plasticizer comprises a triglyceride.

16. A process as defined in claim 14, wherein the cellulose diacetate is present in the polymer composition in an amount of from about 15% to about 85% by weight, such as from about 55% to about 80% by weight and the plasticizer is present in the composition in an amount of from about 12% to about 35% by weight and wherein the closed cell foam has a density of less than 0.9 g/cm³ and wherein the nucleating agent comprises titanium dioxide or talc and wherein the foaming agent comprises a hydrocarbon gas, carbon dioxide, nitrogen gas or mixtures thereof or comprises a carboxylic acid and an alkanolamide.

17. A foam article comprising:
a thermoformed foam substrate comprising a closed cell foam formed from a polymer composition comprising a cellulose ester polymer, the cellulose ester polymer having a degree of acetyl substitution of from about 1.5 to about 3.5, the cellulose ester polymer being blended with a plasticizer, the plasticizer being present in the polymer composition in an amount of from about 8% to about 45% by weight, and wherein the closed cell foam substrate has a density of less than 1.0 g/cm³.

18. A foam article as defined in claim 17, wherein the closed cell foam substrate has a density of less than 0.8 g/cm³.

19. A foam article as defined in claim 17, wherein the plasticizer comprises a triglyceride, a polyethylene glycol, or mixtures thereof.

20. A foam article as defined in claim 17, wherein the foam article comprises packaging, a profile, a tube, or a plank.
